(19) United States
(12) Patent Application Publication
(10) Pub. No.: US 2011/0153346 A1
(43) Pub. Date: Jun. 23, 2011

(54) HEALTH SCREEN AND METHOD FOR CARRYING OUT THE HEALTH SCREEN

(76) Inventor: Tapio Jokinen, Espoo (FI)

(21) Appl. No.: 12/736,606

(22) PCT Filed: Apr. 21, 2009
(86) PCT No.: PCT/FI2009/050295

§ 371 Date: Dec. 21, 2010

(30) Foreign Application Priority Data
Apr. 22, 2008 (FI) 20085340

(51) Int. Cl. G06Q 50/00; G06Q 10/00

(52) U.S. Cl. 705/2

(57) ABSTRACT

The invention relates to a health screen and a method for finding medical deviations, in which patients whose data have at least one desired factor in common are selected as a screening group from the data of the database systems of health service providers. The patient's indicator value describing the data of patients in the screening group is then compared to a norm value describing normal values, and if the patient's indicator value differs from the norm value, a query requiring a reply in machine-readable form is signalled to a third party for receiving a reply to the query, and feedback information is signalled to the database systems of health service providers as triggered by the received reply about the patient who had an indicator value that deviated from the corresponding norm value by at least a predetermined amount.

The invention relates to a health screen and a method for carrying out the health screen. In particular, the invention relates to a method and arrangement for finding medical deviations by means of the health screen.

### BACKGROUND OF THE INVENTION

It is generally known that in connection with visits to a doctor, besides recording such basic information as sex, age and nationality, some health-related data of the patient, such as height, weight, waist circumference, and the hemoglobin, sugar and cholesterol content of the blood are measured or otherwise determined. It is also possible to request and find out other background information, such as information related to the growth of the parents in adolescence or early childhood. It is also known that this information can be saved in databases and that certain statistical operations can be carried out with the information, such as calculating mean values.

However, with the present methods and systems, it is generally not possible to detect even the most common medical deviations early enough (during the early growth of the person), such as celiac disease, potential overweight, short stature (dwarf) or the risk of old-age diabetes. Even in a situation in which a medical deviation is suspected, an observation made in the stage of early growth of the person is often not very reliable.

### SUMMARY OF THE INVENTION

It is an object of the invention to find a solution in which the above mentioned drawbacks of the prior art can be reduced. The invention aims to find a solution to the question as to how the measured information can be used to make a prediction about a person's potential medical deviation as reliably as possible, with as small amounts of data transmission as possible without excessive load on the communication network, and how the potential deviations could be prevented early enough, or at least minimize their negative effects.

The objectives of the invention are achieved by collecting information from the database systems of distributed health service providers, selecting from the collected information a screening group, which consists of persons having at least one desired factor in common (e.g., sex, nationality, age, overweight, high cholesterol), and comparing the indicator value of a person of the screening group indicating at least one data item of the person to a norm value indicating a value regarded as normal in the data of a similar group. If the person's, indicator value differs from the corresponding norm value by at least a predetermined amount, feedback information about the person in question is returned to the database system of the health service provider.

According to a preferred embodiment of the invention, the method also includes signalling a query requiring a reply in machine-readable form to a third party for receiving a reply required in machine-readable form before the feedback information is delivered to the database systems of the health service providers. In the embodiment in question, the feedback information to be delivered to the database systems of the health service providers is preferably compiled at least partly on the basis on the reply received from said third party.

The system according to the invention is characterized in what is set forth in the characterizing part of the system claim 1.

The method according to the invention is characterized in what is set forth in the characterizing part of the method claim 9.

The computer program product according to the invention is characterized in what is set forth in the characterizing part of claim 16, which describes the computer program product.

In addition, other preferred embodiments of the invention are set forth in the dependent claims.

The following concepts, for example, are used in this patent application:
“health screen” is a part of the system according to the invention, a kind of central system, which collects patient information from several database systems of health service providers, analyzes them either entirely independently or with the help of a third party, and thereafter delivers for the use of health service providers the information of patients whose indicator values differ by at least a predetermined amount from the norm value
an “indicator value” is a value describing at least one data item of the patient, such as the body mass index, BMI
a “norm value” is a value related to the information of the patient, which is regarded as normal, such as a BMI regarded as normal in relation to the height of the patient,
“a value regarded as normal” is typically the mean value of a certain data item calculated from a large number of patients, including the range of variation, such as the medium height of a Finnish adult man±normal range of variation.
a “screening group” consists of people who have at least one desired factor in common, such as sex, nationality, age, overweight or high cholesterol.

According to one embodiment of the invention, health service providers are arranged to collect measurement information of patients and to save the information in their database systems, such as the epicrisis systems, to which the central system according to the invention has access. The health screen is preferably arranged to gather together the information saved by various health service providers in their database systems and to select different screening groups from the gathered information. A screening group is preferably formed by selecting from the gathered information the information of the people who have at least one desired factor in common, such as sex, nationality, age, height or weight. The health screen can be arranged to gather the information from the database systems of the health service providers as soon as a new data item is fed to the database system, or alternatively by certain intervals, such as once a day. According to one embodiment, the health service provider can also input the information directly to the database systems of the health screen.

According to an embodiment of the invention, at least one screening group is determined by means of parameters describing the characteristics of the patients in such a way that the data of at least one first parameter describing a characteristic of each patient of said screening group are essentially the same, e.g. all the people belonging to the screening group are of the same sex and/or age. For example, the parameter selections “female” and “25 years” generate a screening group consisting only of women whose age is 25.

In addition, according to one embodiment, the health screen is arranged to form a person's indicator value that represents at least one data item of a person in the screening group, such as the body mass index (the height to weight ratio). In the simplest case, the indicator value may even be a single measurement, such as the waist circumference, or a combination of information, such as the body mass index, BMI. The indicator value can also be a value that has been calculated in a much more complicated way from the measurement data, such as an indicator value describing old-age diabetes, by which the person's risk of developing diabetes in the old age can be estimated, or an indicator value of a growth disorder, by which a potential growth disorder of the person can be estimated.

According to an embodiment of the invention, the health screen is also arranged to calculate itself, by the information it has gathered, for example, a norm value as an indicator value of corresponding information of a person regarded as normal in a similar group.

The invention is preferably also arranged to compare the indicator value of a person in the screening group to the norm value of a similar group and to signal a query requiring a reply in machine-readable form to a third party, if the person's indicator value differs from the norm value of a similar group at least by a predetermined amount. Said query is most preferably a query delivered in electronic form, which also requires a reply in electronic, machine-readable form.

According to an example, a patient's indicator value describing information (such as height) related to at least one other parameter (than said first parameter) of the patients of the screening group is compared to a norm value (such as the medium height of the screening group), which relates to a value related to said second parameter of patients of said screening group regarded as normal. For example, in order to find out if a 10-year old boy has an illness related to short stature, his height data are compared to the height data describing the medium height of such a screening group where the screening group has been selected such that the data describing the parameters (age, sex) of patients belonging to it are essentially the same, e.g. “10 years” and “male”.

According to an embodiment, the signalling of the query comprises signalling the information of the person in question for more detailed analysis to the data processing system of a third party (for example, a consultant or doctor specialized in medical deviations at a university) to a data processing system, which is arranged to signal as a return message, after carrying out the analysis, an indication related to the correctness of the medical status of the patient predicted by the indicator value (in order to detect a possible false interpretation).

According to an embodiment of the invention, the health screen is arranged to signal in machine-readable form a specifying question requiring an answer to the person (whose indicator value differed sufficiently from the norm value) through an electronic medium for receiving an answer to the question in machine-readable form. The health screen is preferably also arranged to generate a feedback message to be signalled to the electronic communication means of the person in question, based on the information used when determining the indicator value and/or the answer received in machine-readable form or a combination thereof.

The health screen is also arranged to generate and signal to each database system of the health service provider feedback information concerning at least those persons of the database system of the health service provider who had an indicator value that differed by at least the predetermined amount from the corresponding norm value. At its simplest, the feedback information may comprise a reference to the data of the person having a detected potential or obvious medical deviation and to said detected deviation, but according to an embodiment, also other possible information, such as the quality and severeness of the detected medical deviation, the nature of the measures required, and the importance and urgency, without being limited to these only.

It is clear that the invention provides a number of advantages, such as an efficient signalling channel and central environment for gathering the information and screening it with regard to the desired parameters, and for making a reliable prediction on the basis of the measured basic information about the patient's present or potential later medical deviation. The basic information may even be information that was not especially measured for this purpose, such as information measured in connection with a routine health check. In addition, the invention provides an efficient signalling channel back to the health service providers even for observing single potential deviations, in which case the prevention of potential deviations early enough or at least the minimization of their negative effects may still be possible. The invention can thus help to achieve savings in the costs caused by medical deviations both on the level of health service providers and the municipal level, and also in a larger scale.

### SHORT SUMMARY OF THE DRAWINGS

In the next section, the preferred embodiments of the invention will be described with reference to the accompanying drawings, in which

FIG. 1 shows an example of a system comprising a health screen for finding medical deviations according to a preferred embodiment,

FIG. 2 shows an example of a method for finding medical deviations according to a preferred embodiment of the invention, and

FIG. 3 shows an example of a computer program product for finding medical deviations according to a preferred embodiment of the invention.

### MORE DETAILED DESCRIPTION OF THE DRAWINGS

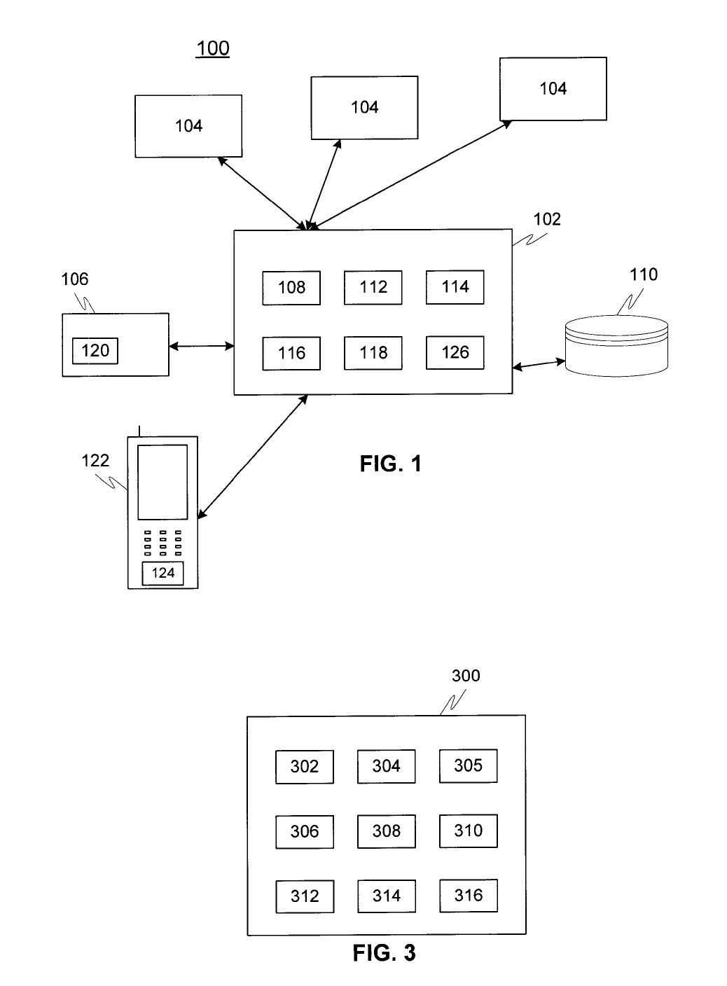

FIG. 1 shows an example of a system 100 for finding medical deviations according to a preferred embodiment of the invention. The system comprises a health screen 102 and a number of preferably distributed database systems of health service providers 104 and a third party 106, to which said health screen has a communication connection 101.

The health screen comprises means 108 for gathering information from the data base systems of the health service providers for the use of the health screen and for being saved in the data base means 110, for example, means 112 for selecting patients from the gathered information in such a way that the data of the patients have at least one desired factor in common, and means 114 for comparing the indicator values of the patients in the screening group to the norm value.

The health screen also comprises means 116 for signalling a query requiring a reply in machine-readable form to a third party 106, such as an outside consultant, like a university research group, and for receiving an answer required in machine-readable form. The means 116 are preferably arranged to signal said query if the patients' indicator value differs from the corresponding norm value by at least a predetermined threshold value. In addition, the health screen comprises means 118 for signalling feedback information to the database systems of the health service providers about a patient who had an indicator value that differed from the corresponding norm value by at least a predetermined amount. The signalling may be triggered, for example, by a reply received by the means 116 to a signalled question, such as the confirmation by an outside party of the correctness of the alarm. Alternatively, the feedback information can be signalled at its simplest already at the comparison stage, when the patient's indicator value differs from the norm value.

According to an embodiment of the invention, the data processing system 106 of a third party may comprise means 120 for receiving and analyzing a query signalled by the health screen and for signalling a return message to the health screen, where the return message is related to the correctness of the medical status of the patient that was predicted by the indicator value.

According to an embodiment of the invention, the health screen 102 may have a communication connection 101 to the patient's electronic terminal device 122, such as the patient's mobile station, in which case the means 116 of the health screen may be adapted to signal a query requiring a reply in machine-readable form to the patient's electronic terminal device 122. The patient's electronic terminal device 122 preferably comprises means 124 for presenting the query to the patient and for signalling an electronic return message in machine-readable form to the health screen as a reply to the query. According to an embodiment of the invention, the means 116 of the health screen may also be adapted to generate and to deliver a feedback message to the patient, such as an automatic voice message, related to the patient's medical deviation.

Furthermore, the system 100, most preferably the health screen 102, comprises means 126 for forming an indicator value related to one or more data items of each patient and/or a norm value corresponding to the indicator value.

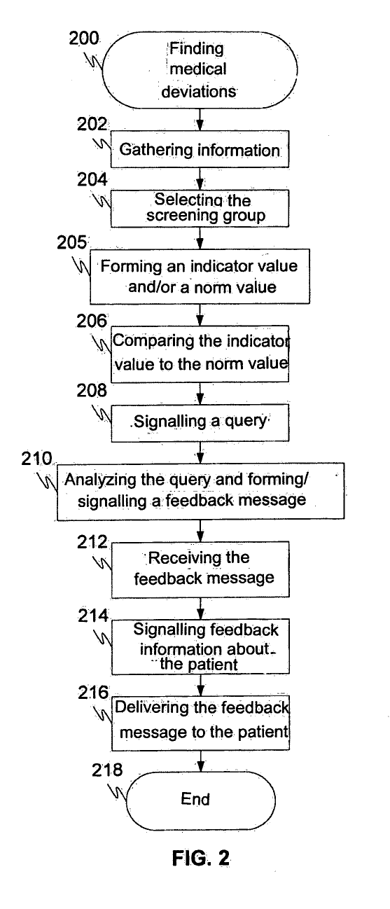

FIG. 2 shows an example of a method 200 for finding medical deviations according to a preferred embodiment of the invention, in which data from the database systems of health service providers are gathered for use by the health screen in step 202, patients having at least one desired factor in common in their data are selected as the screening group from the gathered data in step 204, and finally in step 206 the patient's indicator value relating to at least one data item of the patients in the screening group is compared to the norm value which relates to a value regarded as normal in the data of a similar group.

The method may also have a step 205 for forming a patient's indicator value to represent at least one data item or a combination of several data items of the patient, and a norm value to represent the indicator value of corresponding data of a patient regarded as normal in a group that best corresponds to the screening group. However, the indicator value and/or the norm value can also be formed in some other step. Especially the norm value can be formed in some earlier step.

In step 206, it is checked whether the patient's indicator value differs from the corresponding norm value by at least a predetermined threshold value, and if the indicator value differs so, the process can move directly to step 214 according to a simple embodiment, for signalling to the database system of a health service provider feedback information about the patient who had an indicator value that differed from the corresponding norm value by at least a predetermined amount.

Alternatively, according to an embodiment of the invention, steps 208 to 212 can also be performed, in which case, in step 208, a query requiring a reply in machine-readable form is signalled to a party outside the central system, such as a university consultant. If the indicator value does not differ too much from the norm value, the user can stop the process in step 218, or alternatively move to some other step, or start the process again from some earlier step relating to the analysis of some other data item of the patient, for example.

In step 210, an outside party of the health screen analyses the query, and generates and signals a feedback message related to the correctness of the medical status of the patient that was predicted by the indicator value. According to an embodiment of the invention, in connection with steps 208 and 210, it is possible to signal to the electronic terminal device of the patient a query requiring a reply in machine-readable form, whereafter the electronic terminal device can also signal an electronic return message in machine-readable form as a reply to the query.

In step 212, the required answer in machine-readable form, i.e. the return message, is received, and in step 214, as triggered by the received answer, for example, feedback information is signalled to the database systems of the health service providers about the patient who had an indicator value that differed from the corresponding norm value by at least a predetermined amount. In step 216 it is also possible to generate and deliver to the patient a feedback message, such as an automatic voice message relating to the patient's medical deviation. However, this step is optional.

FIG. 3 shows an example of a computer program product 300 for finding medical deviations according to a preferred embodiment of the invention, in which the computer program product comprises code parts to be carried out by a data processing device, of which part 302 is adapted to gather the information of data base systems of distributed health service providers for the use of the health screen, part 304 is adapted to select from the gathered information as the screening group the patients whose data have at least one desired factor in common, and part 306 to compare a indicator value of a patient relating to at least one data item of the patients of the screening group to a norm value, which relates to a value regarded as normal in the data of a similar group, when said computer program product or said code parts are executed by some data processing device, such as a computer. In addition, the computer program product may comprise a code part 305, which is arranged to form a patient's indicator value to represent at least one data item or a combination of several data items of the patient, and a norm value to represent the indicator value of corresponding data of a patient regarded as normal in a group that best corresponds to the screening group, when said computer program product or said code parts are executed by some data processing device.

In addition, the computer program product 300 preferably comprises a code part 306 for checking the deviation of the patient's indicator value from a corresponding norm value by at least a predetermined threshold value, a code part 308 for signalling a query requiring a reply in machine-readable form to a third party, a code part 310 for receiving a return message and a code part 312 for signalling feedback information to the database systems of health service providers about the patient, when said computer program product or said code parts are executed by some data processing device.

According to an embodiment of the invention, the computer program product 300 may also comprise a code part 314 for signalling a query requiring a reply in machine-readable form to the electronic terminal device of the patient, a code part 316 for receiving an electronic return message as a reply to the query, and for generating a return message, such as an automatic voice message concerning the patient's medical deviation, and delivering it to the patient when said computer program product or said code parts are executed by some data processing device.

Only a few preferred embodiments of the solution according to the invention have been described above. The principle according to the invention can naturally be modified within the scope defined by the claims, with regard to the details of the implementation and the range of use, for example. It is especially to be noted that at least part of the method steps described in FIG. 2 can also be in a different order. In addition, it is to be noted that in accordance with the above scenario, the feedback information is delivered to the service providers' databases, but according to an embodiment of the invention, the information can also be saved in some other database or information systems of the health screen, to which the health service provider has access.

1. A health screen for finding medical deviations, wherein the health screen comprises at least data processing means and data transmission means for establishing an electronic communication connection with an electronic database system of at least one health service provider, the database system comprising information related to parameters describing patients' characteristics, such as weight, age, sex and/or nationality in electronic form, and wherein the health screen is configured to gather, by said electronic communication connection, data related to the patients of the electronic database system for its use,
wherein the health screen is also configured
to determine at least one screening group by parameters describing the patients' characteristics in such a way that the data of at least one first parameter describing the characteristic of each patient of said screening group are substantially the same,
to compare a patient's indicator value describing data related to at least one other parameter of the patients of the screening group to a norm value which relates to a value of the data related to said second parameter of the patients of said screening group that is regarded as normal, or a target value,
and if the patient's indicator value differs from the corresponding norm value by at least a predetermined threshold value,
to generate feedback information to be delivered in electronic form about the patient who had an indicator value that differed from the corresponding norm value by at least a predetermined amount.

2. A health screen according to claim 1, wherein the health screen is also configured to signal said feedback information by said electronic communication connection to the database system of at least the health service provider to whose database system the patient related to the feedback information belonged.

3. A health screen according to claim 2, wherein the health screen also has a communication connection with a third party, and wherein the health screen is also configured to signal a query to said third party, the query being a query requiring a reply in machine-readable form, to receive the reply required in machine-readable form, and to signal said feedback information as triggered by the received reply.

4. The health screen according to claim 3, wherein the health screen is configured to signal a query requiring a reply in machine-readable form for execution to the data processing system of a third party, which is configured, after carrying out the query, to signal an indication as a return message related to the correctness of the medical status of the patient that was predicted by the indicator value.

5. A health screen according to claim 1, wherein the health screen is configured to signal a query requiring a reply in machine-readable form for execution to the electronic terminal device of the patient, which terminal device is configured to signal an electronic return message in machine-readable form as a reply to the query.

6. A health screen according to claim 1, wherein the health screen is configured to generate and deliver to the patient a feedback message, such as an automatic voice message, relating to the patient's medical deviation.

7. A health screen according to claim 1, wherein the health screen is configured to generate said patient's indicator value to represent at least one data item or a combination of several data items of the patient.

8. A health screen according to claim 1, wherein the health screen is configured to form said norm value to represent an indicator value of a patient regarded as normal in a group that best corresponds to the screening group.

9. A method for finding medical deviations by a computerized central system, wherein data in electronic form comprised by an electronic database systems of health service providers and describing patients' characteristics, such as weight, age, height, sex and/or nationality, is collected for the use of the central system by a communication connection connecting the database systems of health service providers and said central system,
wherein the method also comprises:
determining at least one screening group by parameters describing the patients' characteristics in such a way that the data of at least one first parameter describing the characteristic of each patient of said screening group are essentially the same,
comparing a patient's indicator value describing data related to at least one other parameter of the patients of the screening group to a norm value, which relates to a value of the data related to said second parameter of the patients of said screening group that is regarded as normal, or a target value,
and if the patient's indicator value differs from the corresponding norm value by at least a predetermined threshold value,
generating feedback information to be delivered in electronic form about the patient who had an indicator value that differed from the corresponding norm value by at least a predetermined amount.

10. A method according to claim 9, wherein said feedback information is signalled by said electronic communication connection to the database system of at least the health service provider to whose database system the patient related to the feedback information belonged.

11. A method according to claim 9, wherein a query requiring a reply in machine-readable form is signalled to the data processing system of a third party which is, after carrying out the query, configured to signal as a reply an indication concerning the correctness of the medical status of the patient that was predicted by the indicator value, said reply is received from a third party, and said feedback information is signalled to the database system of the health service provider as triggered by the received reply.

12. A method according to claim 9, wherein a query requiring a reply in machine-readable form is signalled to the patient's electronic terminal device, which is configured to signal an electronic return message in machine-readable form as a reply to the query.

13. A method according to claim 9, wherein a feedback message, such as an automatic voice message is generated and delivered to the patient, relating to the patient's medical deviation.

14. A method according to claim 9, wherein said patient's indicator value is formed to represent at least one data item or a combination of several data items of the patient.

15. A method according to claim 9, wherein said norm value is formed to represent an indicator value of corresponding data of a patient regarded as normal in a group that best corresponds to the screening group.

16. A computer program product for finding medical deviations, comprising code parts stored on a readable medium for execution by a data processing device for carrying out the actions of claim 9.
